(19) United States
(12) Patent Application Publication
(10) Pub. No.: US 2022/0280390 A1
(43) Pub. Date: Sep. 8, 2022

(54) TABLET DISPENSING APPARATUS

(71) Applicant: TOSHO, INC., Tokyo (JP)

(72) Inventor: Yoshihito Omura, Tokyo (JP)

(21) Appl. No.: 17/635,913

(22) PCT Filed: Aug. 17, 2020
(86) PCT No.: PCT/JP2020/030997

§ 371 Date: Feb. 16, 2022

(30) Foreign Application Priority Data
Aug. 19, 2019 (JP) 2019-150055
Feb. 12, 2020 (JP) 2020-021938

(51) Int. Cl. A61J 7/00; B65B 35/10

(52) U.S. Cl. CPC A61J 7/0076; B65B 35/10

(57) ABSTRACT

A tablet dispensing apparatus that allows the inside of tablet collecting mechanisms at the relevant locations to be cleaned altogether even if tablet feeders of a multiple tablet-compatible type are provided in a multilevel arrangement. A plurality of tablet feeder storage portions are vertically arranged in line and incorporated into a medicine storage portion of a tablet dispensing apparatus to be individually drawn out forward, and a common upper tablet collecting portion is provided on one of the two sides of the tablet feeder storage portions to be also drawn out forward. Consequently, it is possible to clean the inside of the upper tablet collecting mechanism at the relevant location altogether, even if the tablet feeders are provided in a multilevel arrangement.

### TECHNICAL FIELD

The present invention relates to a tablet dispensing apparatus operable to collect tablets dropped and discharged from tablet feeders, which are configured to store a large number of tablets and sequentially discharge the tablets, and separately pack the tablets using a packing device. The present invention relates in particular to a tablet dispensing apparatus configured to three-dimensionally hold tablet feeders in a medicine storage portion and allow the tablet feeders to be drawn forward out of the medicine storage portion.

### BACKGROUND ART

A tablet dispensing apparatus (see Patent Documents 1 to 4, for example) basically includes: a medicine storage portion configured to store a large number of tablet feeders and an upper tablet collecting portion configured to guide and allow tablets discharged from the tablet feeders to be dropped downward; a lower tablet collecting portion located below the medicine storage portion and configured to collect and allow the dropped tablets to be dropped downward; a packing device located below the lower tablet collecting portion and configured to input the dropped tablets into separated housing portions of a dispensing band and thereafter seal opening portions of the housing portions; and a controller (control device) formed from a microprocessor system etc. In most tablet dispensing apparatuses according to the related art, the large number of tablet feeders are held in the medicine storage portion in a cubic shape in line in the up-down direction (vertical direction), the left-right direction (lateral direction), and the front-rear direction (depth direction). In some of such tablet dispensing apparatuses according to the related art, at least a plurality of tablet feeders arranged in line in the front-rear direction can be drawn forward together out of the medicine storage portion.

Most tablet dispensing apparatuses according to the related art are also equipped with a manual tablet dispenser. Further, even tablet dispensing apparatuses according to the related art that are not equipped with a manual tablet dispenser secure an equipment space for possible addition of a manual tablet dispenser.

The manual tablet dispenser is basically used to manually put tablets that are not present in the medicine storage portion into a large number of sectioned chambers. Therefore, the manual tablet dispenser is equipped with a fixed or removable manual dispensing unit in which a large number of sectioned chambers to which the tablets are to be manually dispensed are disposed in the front-rear and left-right directions, and a sequential discharge mechanism portion operable to allow the tablets to be dropped downward by opening the bottom of the sectioned chambers, usually one chamber at a time.

The tablet feeders are each equipped with a tablet cassette (small container portion) configured to store and hold a large number of tablets of one type, usually input collectively, and allow the tablets to be sequentially dropped downward when the tablet cassette is driven to discharge the tablets, and a base portion (drive portion) configured to support the tablet cassette and drive the tablet cassette to discharge the tablets.

Most tablet cassettes are of a removable, so-called specific tablet-dedicated type configured with a focus on not limiting the location where tablets can be supplied [see a tablet cassette 51 in FIG. 9A and Patent Documents 1 to 4]. There have recently been developed tablet feeders of a so-called multiple tablet-compatible type provided with an adjustment function to be adapted to the shapes or the dimensions of individual tablets, to be usable in common for tablets of a variety of shapes and sizes [see a tablet cassette 52 in FIGS. 9B and 9C and Patent Document 5]. Besides the tablet feeders each including a removable tablet cassette, tablet feeders of a fixed cassette type in which a tablet cassette is integrated with a drive portion have also been put into practical use (see paragraph [0054] of Patent Document 5, for example).

### RELATED-ART DOCUMENTS

### Patent Documents

[Patent Document 1] JP 2003-237702 A
[Patent Document 2] JP 2006-288576 A
[Patent Document 3] JP 2013-078525 A
[Patent Document 4] JP 2013-085666 A
[Patent Document 5] JP 2015-023969 A

### SUMMARY OF INVENTION

### Technical Problem

The tablet feeders of the multiple tablet-compatible type do not require cassette replacement or use of different cassettes even if the types or the shapes of tablets are different to a certain degree, and thus can be highly used in common. However, the tablet feeders of this type are complicated in structure, and therefore it is difficult to increase the quantity of tablets to be stored. When a tablet cassette is rendered removable, in addition, the quantity of tablets to be stored may be further sacrificed. Therefore, most tablet feeders of the multiple tablet-compatible type are of a fixed cassette type, and used as incorporated in a part of the medicine storage portion.

As the need for the tablet feeders of the multiple tablet-compatible type increases, it is attempted to implement a multilevel arrangement in which a plurality of tablet feeder storage portions, in which a plurality of tablet feeders are disposed in the front-rear direction, are vertically arranged in line. In that case, however, it is desirable that units in each level can be individually drawn out forward.

If the upper tablet collecting portion is accordingly vertically divided finely in correspondence with the tablet feeder storage portions in the respective levels as in the devices according to the related art, the inside of the upper tablet collecting portion cannot be cleaned altogether, which is troublesome.

It is an object of the present invention to provide a tablet dispensing apparatus configured to allow the inside of an upper tablet collecting portion to be cleaned altogether, even if tablet feeder storage portions are provided in a multilevel arrangement.

In addition to the above object, it is another object of the present invention to provide a tablet dispensing apparatus configured to facilitate supply of tablets when tablets are to be supplied to tablet feeders mounted to tablet feeder storage portions.

It is still another object of the present invention to provide a tablet dispensing apparatus configured to detect whether or not lids of tablet feeders are appropriately closed.

It is an additional object of the present invention to provide a tablet dispensing apparatus configured to facilitate a visual check of the inside of even tablet feeders of a multiple tablet-compatible type, even if it is difficult to visually check the inside of tablet feeders when a plurality of tablet feeders of a multiple tablet-compatible type to be opened and closed by a lid are fixed to tablet feeder storage portions.

### Solution to Problem

In order to facilitate understanding, the components of the present invention will be described below using reference numerals given in the accompanying drawings. The reference numerals given here should not be construed as limiting the present invention to the embodiments.

A tablet dispensing apparatus according to the present invention includes: a plurality of tablet feeder storage portions 20A to 20C configured to store a plurality of tablet feeders 52 and disposed in line in a vertical direction; an upper tablet collecting portion 30 disposed along the plurality of tablet feeder storage portions 20A to 20C and including a tablet falling path that guides and allows tablets to be dropped downward from the plurality of tablet feeder storage portions 20A to 20C; a medicine storage portion 13 configured to house at least the plurality of tablet feeder storage portions 20A to 20C and the upper tablet collecting portion 30; and a lower tablet collecting portion 16 disposed below the upper tablet collecting portion 30 and configured to guide the tablets dropped from the upper tablet collecting portion 30 to a dispensing portion. The tablet dispensing apparatus according to the present invention also includes a plurality of storage portion sliding mechanisms 22 configured to support the plurality of tablet feeder storage portions 20A to 20C to be individually slidable forward; and a collecting portion sliding mechanism 37 configured to support the upper tablet collecting portion 30 to be slidable forward independently of the plurality of tablet feeder storage portions 20A to 20C.

In the tablet dispensing apparatus according to the present invention, when the plurality of tablet feeder storage portions 20A to 20C are disposed in the medicine storage portion 13, the storage portion sliding mechanism 22 is individually provided for each of the tablet feeder storage portions 20A to 20C, which allows the lower tablet feeder storage portion to be drawn forward out of the medicine storage portion 13 with the upper tablet feeder storage portion kept housed in the medicine storage portion. Then, tablets can be supplied not only to the tablet feeders held by the tablet feeder storage portion located in the uppermost level, but also to the tablet feeders held by the other, lower tablet feeder storage portion inside the medicine storage portion 13 without caring about the presence of the upper tablet feeder storage portion.

Moreover, the upper tablet collecting portion 30 which guides tablets discharged from the plurality of tablet feeder storage portions 20A to 20C is disposed right next to the plurality of tablet feeder storage portions 20A to 20C which are vertically continuous. In addition, the upper tablet collecting portion 30 can also be drawn out of the medicine storage portion 13 separately from the tablet feeder storage portions. As a result, it allows the inside of the upper tablet collecting portion to be cleaned altogether even if the tablet feeder storage portions are provided in a multilevel arrangement. Thus, with the present invention, it is possible to provide a tablet dispensing apparatus configured to allow the inside of the upper tablet collecting portion to be cleaned altogether, even if the tablet feeders of the multiple tablet-compatible type are provided in a multilevel arrangement.

The tablet dispensing apparatus may further include a draw-out regulating structure that allows the upper tablet collecting portion 30 to be drawn out forward only when all the plurality of tablet feeder storage portions 20A to 20C are drawn out forward. By providing the draw-out regulating structure, the upper tablet feeder storage portion and the lower tablet feeder storage portion are inevitably drawn forward out of the medicine storage portion 13 to an equivalent degree or more when the upper tablet collecting portion 30 is drawn forward out of the medicine storage portion 13.

Therefore, even in an unexpected, undesirable situation in which tablets unexpectedly overflow from the tablet feeders 52 held by the tablet feeder storage portions 20A to 20C, such overflowing tablets are dropped in the upper tablet collecting portion 30 or to a location forward of the medicine storage portion 13. In addition, such overflowing tablets are not scattered to a location off the tablet falling path inside the medicine storage portion 13 etc. As a result, the mental burden on a worker that supplies tablets and cleans members is reduced.

The draw-out regulating structure may be provided on one of the two sides of the upper tablet collecting portion 30. With this configuration, the upper tablet collecting portion 30 can be drawn out so as to form a free space on the other of the two sides of the upper tablet collecting portion 30 when the upper tablet collecting portion 30 is drawn forward out of the medicine storage portion 13. As a result, an operator for the upper tablet collecting portion 30 can use the free space to perform cleaning of the tablet falling path.

The present invention achieves a remarkable effect when the tablet feeders 52 are configured to be able to house a plurality of tablets of one kind selected from a large number of kinds of tablets of different shapes and dimensions and have a function of discharging tablets, one at a time, and the tablet feeders 52 and the tablet feeder storage portions (20A to 20C) are configured such that tablets are supplied with the plurality of tablet feeders mounted to the tablet feeder storage portions.

As a matter of course, the present invention is also applicable to a tablet dispensing apparatus structured such that: the medicine storage portion 13 houses a plurality of standard tablet feeder storage portions 18 including a plurality of standard tablet feeders 51 each including a tablet cassette configured to store a plurality of tablets of the same shape and size and of the same kind, and one or more standard upper tablet collecting portions 17 disposed along the plurality of standard tablet feeder storage portions 18 and including one or more tablet falling paths that guide and allow the tablets to be dropped downward from the plurality of standard tablet feeder storage portions 18; a plurality of intermediate collecting portions are disposed between the one or more standard upper tablet collecting portions 17 and the upper tablet collecting portion 30, and the lower tablet collecting portion 16, the plurality of intermediate collecting portions being configured to temporarily store the plurality of tablets dropped from the one or more standard upper tablet collecting portions 17; and the tablets are dropped from the plurality of intermediate collecting portions to the lower tablet collecting portion 16.

Preferably, the upper tablet collecting portion 30 has an assembly structure such that an opposite side surface portion, namely a second side wall 38, that is opposite to a side surface portion, namely a first side wall 35. The opposite side surface portion faces the plurality of tablet feeder storage portions 20A to 20C when the upper tablet collecting portion 30 is drawn forward and prevents an outflow of powder from the tablet falling path when the upper tablet collecting portion 30 is housed in the medicine storage portion 13. The opposite side surface portion enables cleaning of the tablet falling path when the upper tablet collecting portion 30 is drawn out of the medicine storage portion 13. In the assembly structure, the side surface portion (first side wall 35) can be formed from a plate material to be inclined about a lower end portion thereof in a direction away from the plurality of tablet feeder storage portions 20A to 20C when the upper tablet collecting portion 30 is drawn forward. With this configuration, not only the work of cleaning the tablet falling path etc. inside the upper tablet collecting portion 30 but also the work of removing and mounting a side plate can be performed easily and immediately.

The tablet feeder storage portions may each include a shelf 23 supported by the storage portion sliding mechanism and to which the plurality of tablet feeders 52 are mounted in a row, and a front panel 25 disposed at a front end portion of the shelf 23 and extending in a direction orthogonal to the shelf 23. In this case, preferably, a part of the front panel 25 faces forward in a sliding direction of the upper tablet collecting portion 30 to constitute a part of the draw-out regulating structure (25). With such a structure, the draw-out regulating structure (25) can be easily constituted.

A movable rack 24 may be provided on a front surface of the front panel 25, the movable rack 24 being supported on the front panel 25 via a hinge structure to be displaceable between a horizontal posture and a vertical posture. With this configuration, the movable rack 24 can be conveniently used to place small articles thereon. In addition, the movable rack 24 can be utilized as a location to place thereon things that are necessary for work such as handling a container for tablets to be supplied or cleaning the upper tablet collecting portion 30, irrespective of how the plurality of tablet feeder storage portions are drawn out forward.

Preferably, the tablet dispensing apparatus further includes a plurality of draw-out locking mechanisms 40 disposed correspondingly to the plurality of tablet feeder storage portions 20A to 20C and configured to prevent the plurality of tablet feeder storage portions 20A to 20C from sliding forward along the storage portion sliding mechanisms 22, respectively. If the draw-out locking mechanisms 40 are provided for the storage portion sliding mechanisms 22, respectively, the tablet feeder storage portions 20A to 20C can be prevented from being carelessly drawn out to be supplied with wrong tablets. If the draw-out locking mechanisms are disposed at the front end portion of the tablet feeder storage portions 20A to 20C or the front end portion of the medicine storage portion, maintenance work such as repair and replacement required when broken can be easily performed.

Preferably, the tablet dispensing apparatus further includes a locked state detecting portion 46 configured to detect whether or not the plurality of draw-out locking mechanisms 40 are in a locked state. In addition, when the plurality of tablet feeders 52 each have a tablet input port in an upper surface thereof, and the tablet feeder storage portions 20A to 20C include a plurality of lids 52a operable to individually open and close the tablet input ports of the plurality of tablet feeders 52. Preferably, the tablet dispensing apparatus further includes a lid open-close state detecting portion 29 configured to detect whether or not the plurality of lids 52a are in an opened state or a closed state. When the locked state detecting portion 46 and the lid open-close state detecting portion 29 are provided, it is detected that the tablet feeder storage portions 20A to 20C have been drawn out, and that the lids 52a of the tablet feeders 52 have been opened, which makes it possible to determine whether or not it is assumed that tablets have been input to an appropriate tablet feeder. In addition, it is also detected that the tablet feeder storage portions 20A to 20C have been pushed back into the medicine storage portion 13, and that the lids 52a of the tablet feeders 52 have been closed, which makes it possible to determine whether or not the tablet feeder 52 can initiate discharging tablets with the tablet feeder storage portions 20A to 20C locked. Thus, by providing such detecting portions, it is possible to provide a tablet dispensing apparatus configured to detect whether the lids 52a of the tablet feeders 52 are appropriately closed when the tablet feeder storage portions 20A to 20C are locked.

Preferably, the draw-out locking mechanisms 40 include an electric lock operating mechanism that is electrically operable and a manual lock operating mechanism that is manually operable. In this case, preferably, a main portion of the electric lock operating mechanism is mounted to the medicine storage portion 13, and a main portion of the manual lock operating mechanism is mounted to the tablet feeder storage portions 20A to 20C. In addition, preferably, the draw-out locking mechanisms 40 are configured to be able to be unlocked by operation of any of the electric lock operating mechanism and the manual lock operating mechanism. With this configuration, electric wires can be easily installed, for example, since electric portions of the draw-out locking mechanism 40 are centrally located in the medicine storage portion 13. Moreover, work such as inspection and maintenance, which is performed with power supply blocked for safety etc., can be easily performed, since the draw-out locking mechanism can be unlocked by not only operation of the electric portions but also operation of manual portions.

The lid open-close state detecting portion 29 is configured to be able to detect whether or not the lids 52a are opened enough to allow the tablets to be input through the tablet input ports and whether or not the lids are completely closed. With this configuration, it is possible to adequately determine a half opened state and a half closed state. That is, it is detected not only that the tablet feeder storage portions are drawn out, but also that the lids of the tablet feeders are fully opened, not only just opened, which makes it possible to determine with high probability whether or not it is assumed that tablets have been input to an appropriate tablet feeder. In addition, it is also detected that the tablet feeder storage portions have been pushed back into the medicine storage portion, and that the lids of the tablet feeders are completely closed, not just closed to a certain degree, which makes it possible to determine whether or not the tablet feeder can proceed to discharge tablets with the tablet feeder storage portions locked.

Preferably, the lids 52a are formed from a transparent material that allows looking inside the tablet feeders 52 from above. With this configuration, it is possible to provide a tablet dispensing apparatus configured to facilitate a visual check of the inside of even tablet feeders of the multiple tablet-compatible type. Additionally, preferably, the lids 52a are each provided with a half mirror 52b configured to allow looking inside the tablet feeders 52 from above and to reflect light directed upward from below. If the lids of the tablet feeders are rendered transparent and provided with a semi-transparent mirror (half mirror), the half mirror can be freely used as transparent and reflective at any time, even for tablet feeders of the multiple tablet-compatible type simply with a transparent lid which are seeable when looked down at but which are not easily seeable when looked up at. As a result, the content of the tablet feeders can be visually checked, whether the tablet feeders are in the upper level or the lower level and whether the eye position of a visual checker is high or low.

Preferably, the tablet feeder storage portions 20A to 20C are each provided with an emitting device (e.g. LEDs) provided in proximity to the plurality of tablet feeders 52 to light up in order to indicate a tablet feeder 52 that needs to be supplemented with the tablets; and the lids 52a are each configured to introduce light inside the tablet feeders from the light emitting devices corresponding thereto. If light emitting devices are provided and light passes through the lids of the tablet feeders from the outside to the inside when the light emitting devices are lit up, the entire lid is brightened or colored, since the light is more or less scattered when the light passes through the lid or is applied to the inner surface of the lid when the corresponding light emitting device is lit up to indicate the tablet feeder as the tablet input destination to the worker. As a result, even a lid formed from a transparent material is not dazzling, and is easily visually recognizable. In addition, whether or not the light emitting devices are lit up can be visually recognizable easily and adequately, even if the light emitting devices are provided at a location at which the light emitting devices are not easily directly visually recognizable, e.g. behind the lids or the bodies of the tablet feeders. Therefore, a further advantage that the constraint on the arrangement of members is relaxed can be enjoyed.

Further, preferably, the lids 52a are each provided with a light scattering portion 52d configured to diffuse light from the light emitting devices introduced inside the tablet feeders. The light scattering function is enhanced by providing the light scattering portion 52d, which enhances viewability. The half mirror 52b may also be used as the light scattering portion 52d. Viewability can be conveniently enhanced by directing light transmitted from the light emitting devices to the half mirror.

When externally mounting an operation panel for inputting instructions to the medicine storage portion, the operation panel is rendered easily changeable in position using an arm etc. This makes it easy to perform work such as inputting instructions related to tablet supply work which is performed with the tablet feeders drawn out of the medicine storage portion.

### BRIEF DESCRIPTION OF DRAWINGS

FIG. 1A is a front view illustrating the appearance of a tablet dispensing apparatus according to a first embodiment of the present invention, and FIG. 1B is a front view illustrating the inside thereof.

FIGS. 2A to 2D are each a left side view of the tablet dispensing apparatus, and FIG. 2E is a perspective view of the front surface of a medicine storage portion.

FIGS. 3A to 3C are each a perspective view of a tablet feeder storage portion.

FIG. 4A is a perspective view of a tablet feeder of a multiple tablet-compatible type with an opened lid, and FIG. 4B is a side view of a tablet feeder with a closed lid and a tablet feeder arrangement shelf.

FIGS. 5A and 5B are each a left side view of the tablet dispensing apparatus, and FIG. 5C to 5E are each a perspective view of an upper tablet collecting portion.

FIG. 6A is a front view of an essential portion of a draw-out locking mechanism, FIG. 6B is a plan view thereof, and FIGS. 6C and 6D are each a front view thereof.

FIG. 7 is a side view of a tablet feeder of a multiple tablet-compatible type with a closed lid and a tablet feeder arrangement shelf according to a second embodiment of the present invention.

FIG. 8 is a side view of a tablet feeder of a multiple tablet-compatible type with a closed lid and a tablet feeder arrangement shelf according to a third embodiment of the present invention.

FIG. 9A includes a left side view, a front view, and a right side view of a cassette for a tablet feeder of a specific tablet-dedicated type, FIG. 9B includes a left side view, a front view, and a right side view of a small tablet feeder of a multiple tablet-compatible type, and FIG. 9C is a left side view of a large tablet feeder of a multiple tablet-compatible type.

### DESCRIPTION OF EMBODIMENTS

Tablet dispensing apparatuses according to embodiments of the present invention will be described in detail below with reference to the drawings.

### First Embodiment

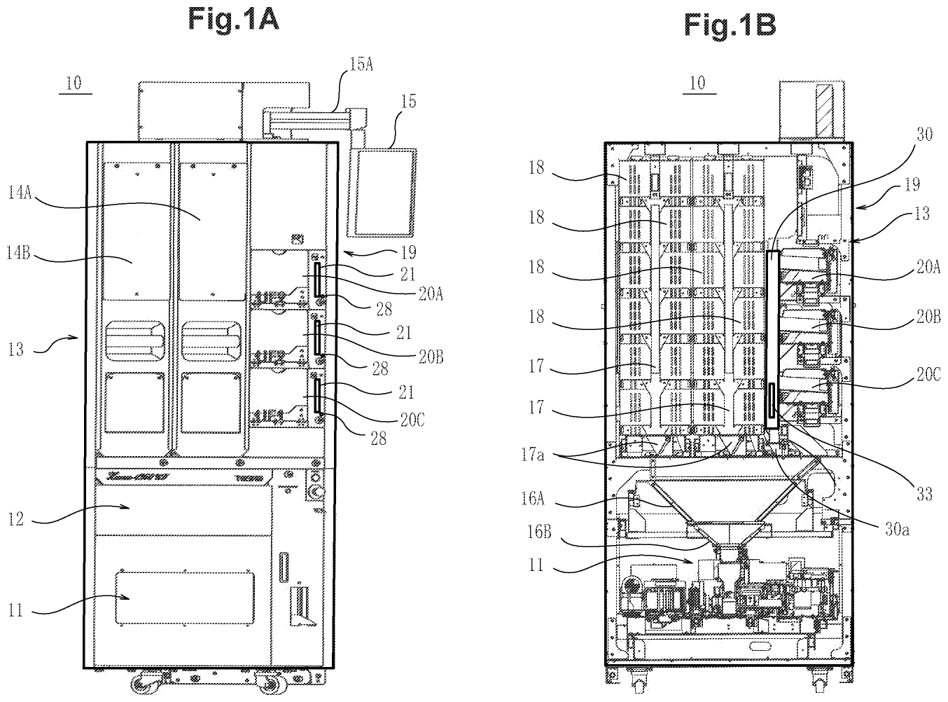

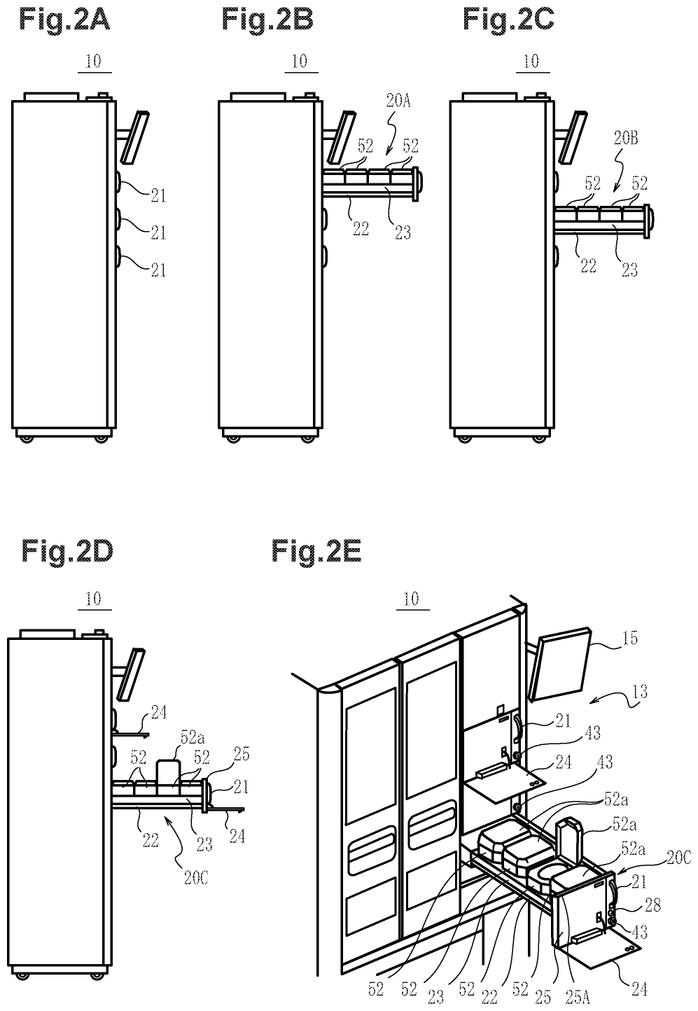

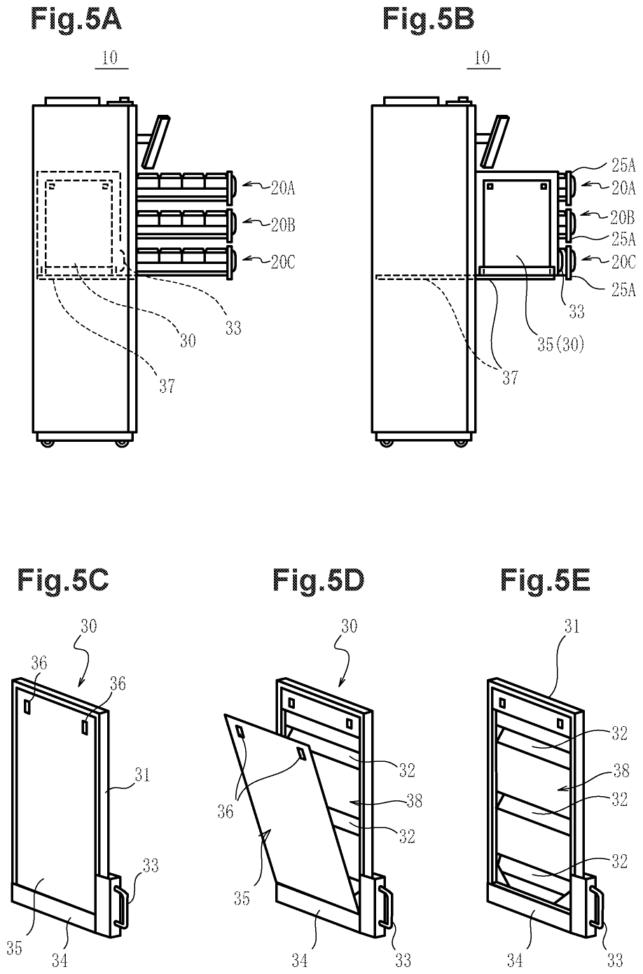

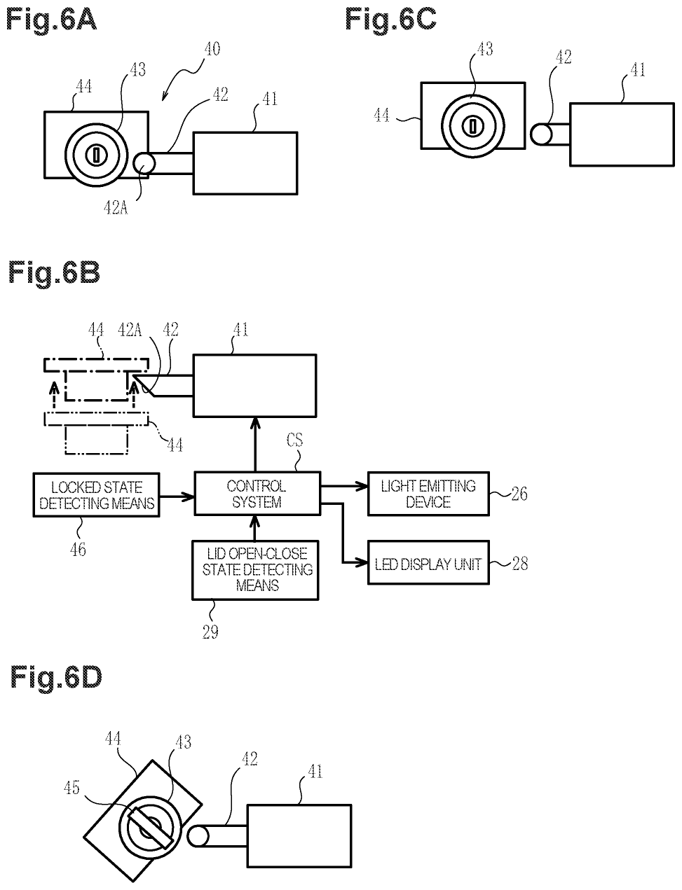

A specific configuration of a tablet dispensing apparatus according to a first embodiment of the present invention will be described with reference to the drawings. FIG. 1A is a front view illustrating the appearance of a tablet dispensing apparatus 10, and FIG. 1B is a front view illustrating the inside of the tablet dispensing apparatus 10. FIGS. 2A to 2D are each a left side view of the tablet dispensing apparatus 10, and FIG. 2E is a perspective view of the front surface of a medicine storage portion 13. FIGS. 5A and 5B are each a left side view of the tablet dispensing apparatus 10, and FIGS. 5C to 5E are each a perspective view of an upper tablet collecting portion 30. FIG. 6A is a front view of a draw-out locking mechanism 40, FIG. 6B is a plan view thereof, and FIGS. 6C and 6D are each a front view thereof.

The tablet dispensing apparatus 10 [see FIG. 1A] includes a packing device 11 in the lower level, a manual tablet dispensation device-equipped portion 12 provided above the packing device 11, a medicine storage portion 13 provided above the manual tablet dispensation device-equipped portion 12, a touch screen 15 supported by an arm 15A to be easily movable in position, and a control system CS [see FIG. 6B] housed inside a housing 19. Two tablet feeder storages 14A and 14B and three tablet feeder storage portions 20A to 20C are incorporated in the medicine storage portion 13, which is constituted in the housing 19, to be drawable forward. In this example, the two tablet feeder storages 14A and 14B are arranged in two lateral lines. However, tablet feeder storages may be provided in three or more lateral lines, or may be provided in a single line, and the tablet feeder storages 14A and 14B may be provided in three or more lateral lines, or may be provided in a single line. The tablet feeder storages may each be vertically divided, and the upper and lower divided storages may each be drawn out forward.

In the present embodiment, the three tablet feeder storage portions 20A to 20C are disposed in three vertical levels and one vertical line to constitute one storage portion line. However, the tablet feeder storage portions may be disposed in any number of vertical levels as long as the number is two or more. In addition, a plurality of storage portion lines may be disposed in line in the lateral direction.

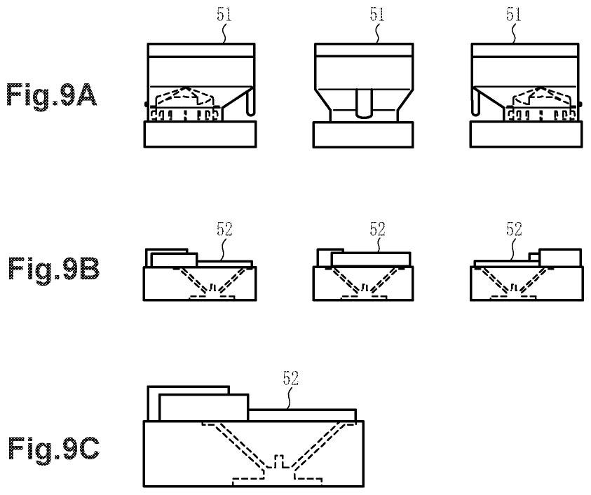

As illustrated in FIG. 1B, 24 standard tablet feeder storage portions 18 are provided inside the two tablet feeder storages 14A and 14B which are disposed in the medicine storage portion 13 which occupies the upper half of the tablet dispensing apparatus 10, the standard tablet feeder storage portions 18 being arranged in six vertical levels and two lateral lines and each including a tablet feeder line constituted by arranging a plurality of standard tablet feeders 51 of a specific tablet-dedicated type illustrated in FIG. 9A in the front-rear direction. A standard upper tablet collecting portion 17 is provided to vertically penetrate between the standard tablet feeder storage portions 18 which are arranged in two lateral lines. Tablets discharged from the standard tablet feeders 51, of the specific tablet-dedicated type, in the standard tablet feeder storage portions 18 are guided to a lower tablet collecting portion 16A provided therebelow by the standard upper tablet collecting portion 17. The structure of the tablet feeder storages 14A and 14B is described in detail in Japanese Patent No. 5557819, for example.

As illustrated in FIGS. 1B, 2, and 3, a plurality of tablet feeders 52 of a multiple tablet-compatible type are disposed in the tablet feeder storage portions 20A to 20C which occupy a part of the medicine storage portion 13. In addition, the upper tablet collecting portion 30 is also provided as hidden behind a front panel 25, to be discussed later, of the tablet feeder storage portions 20A to 20C. A grip 33 provided on the front surface of the upper tablet collecting portion 30 is also hidden behind the front panel 25.

The upper tablet collecting portion 30 leads tablets discharged from the tablet feeders 52 of the tablet feeder storage portions 20A to 20C to the lower tablet collecting mechanism 16A which is provided therebelow. The upper tablet collecting portion 30 receives tablets discharged from the tablet feeders 52, of the multiple tablet-compatible type, in the tablet feeder storage portions 20A to 20C.

A funnel-shaped receiving portion 17a is provided under each of the standard upper tablet collecting portions 17, and a funnel-shaped receiving portion 30a that is smaller than the receiving portion 17a is provided under the upper tablet collecting portion 30.

A first lower tablet collecting portion 16A, a second lower tablet collecting portion 16B, and the packing device 11 are housed inside the housing 19 of the tablet dispensing apparatus 10, at positions below the medicine storage portion [see FIG. 1B]. The first lower tablet collecting portion 16A has a large funnel-shaped collecting structure to receive and collect tablets separately dropped downward from the receiving portions 17a under the two standard upper tablet collecting portions 17 of the medicine storage portion 13 and the receiving portion 30a under the upper tablet collecting portion 30, and feed the tablets to the packing device 11 which is provided therebelow. In addition, the second lower tablet collecting portion 16B has a small collecting structure to receive tablets sequentially fed from a manual tablet dispenser (not illustrated) of the manual tablet dispensation device-equipped portion 12, and also feed the tablets to the packing device 11. The packing device 11 feeds dispensing paper folded in half in the longitudinal direction, and receives the tablets dropped from the first and second lower tablet collecting portions 16A and 16B in portions of the dispensing paper separated to a predetermined width to dispense the tablets.

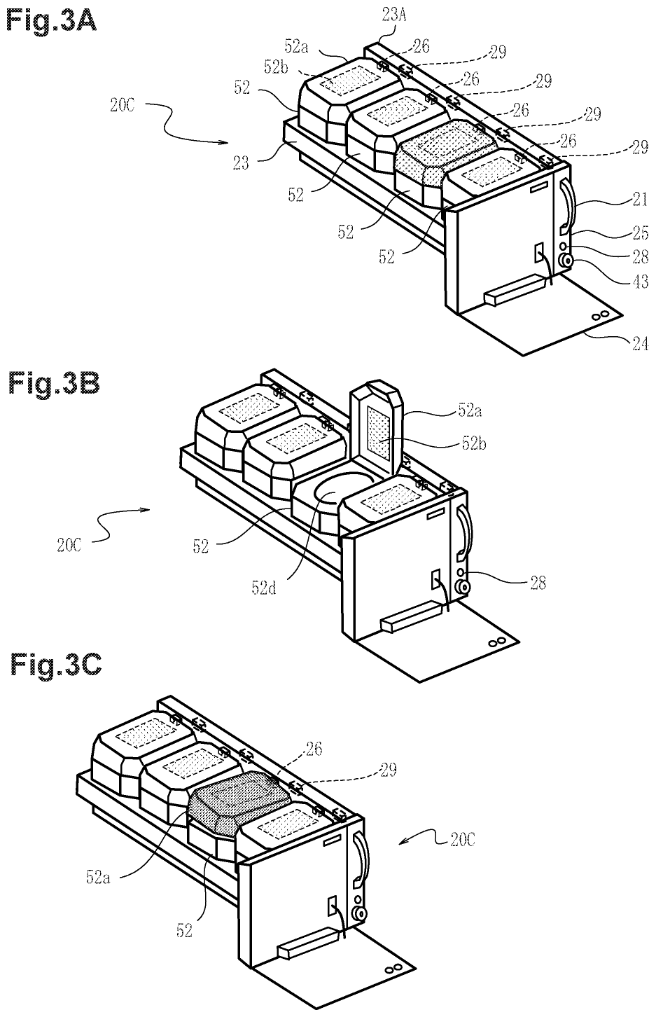

A grip 21 is provided on the front surface of the tablet feeder storage portions 20A to 20C illustrated in FIGS. 1A and 2A to 2E. The tablet feeder storage portions 20A to 20C are supported by a storage portion sliding mechanism 22 to be slidable in the front-rear direction [see FIGS. 2B to 2E]. As a result, the tablet feeder storage portions 20A to 20C can be individually drawn out forward and pushed in rearward. Specifically, a shelf 23 configured to hold four tablet feeders 52 of the multiple tablet-compatible type arranged in a row in the front-rear direction is supported by the storage portion sliding mechanism 22 to be slidable in the front-rear direction. As illustrated in FIGS. 2D and 2E and 3A to 3C, the front panel 25 which is fixed to the front end of the shelf 23 of each of the tablet feeder storage portions 20A to 20C is also provided with a movable rack 24, a manual lock 43, and an LED display unit 28, to be described in detail later, etc., in addition to the grip 21.

The structure of the tablet feeders 52 of the multiple tablet-compatible type is different from the structure of the standard tablet feeders 51 of the specific tablet-dedicated type, which is mostly supplied with tablets of the same type, while the tablet feeders 52 may be of a removable cassette type as with the standard tablet feeders 51. The tablet feeders 52 are structured to be usable for tablets of a variety of shapes and sizes by implementing a simple adjustment as discussed already. Specifically, the tablet feeders 52 can be structured to be usable for tablets of a variety of shapes and sizes by replacing sample tablets (see Patent Document 5), for example. From the viewpoint of suppressing the occurrence of an error such as mishandling of tablets during tablet supply work as much as possible, the tablet feeders 52 are of a fixed cassette type in which the cassette is normally fixed, except during maintenance work (see paragraph [0054] of Patent Document 5).

As illustrated in FIGS. 2D and 2E and 3A to 3C, a lid 52a that can be manually opened and closed is provided at a tablet input port on the upper surface of the tablet feeders 52 of the multiple tablet-compatible type. The control system CS [see FIG. 6B] selects one of the tablet feeders 52 as the cassette as the tablet input destination. The LED display unit 28 on the front surface of one of the tablet feeder storage portions 20A to 20C that carries the selected tablet feeder 52 is lit up to clearly indicate that the tablet feeder storage portion is to be drawn out.

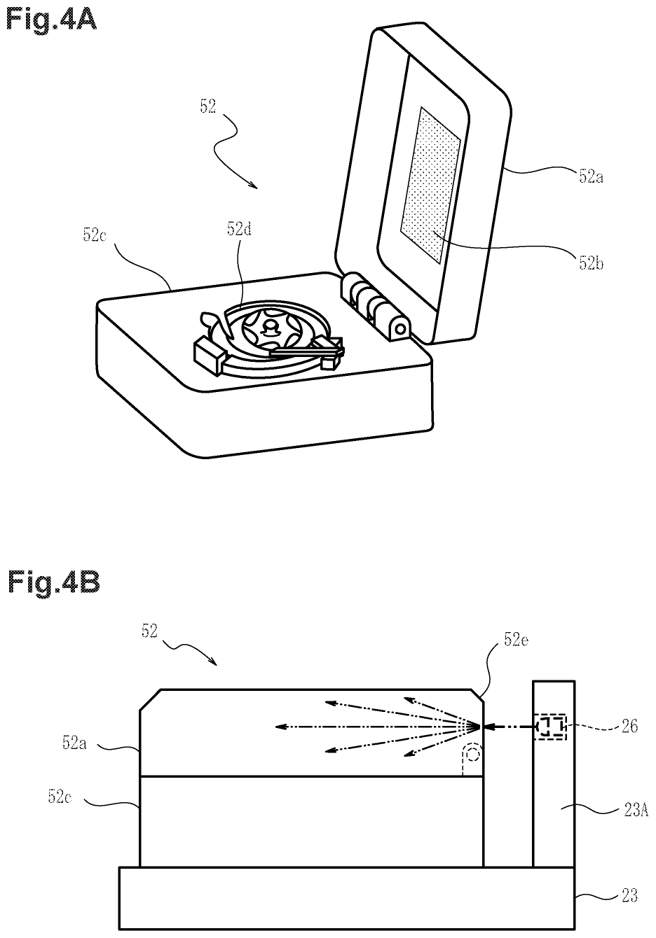

Specifically, the tablet feeders 52 of the multiple tablet-compatible type (see FIGS. 3 and 4) are provided with an openable lid 52a coupled to the upper part of the rear end (right end in FIG. 4) of a container portion 52c via a hinge structure, and a half mirror 52b (semi-transparent mirror) affixed to substantially the center of the inner surface of the lid 52a. When the front end portion of the lid 52a is pushed up using a finger etc., the lid 52a is turned toward the upper rear (upper right in FIG. 4) to open the upper surface (a tablet input port 52d, in particular) of the container portion 52c to allow input of tablets [see FIG. 4A]. When the front end portion of the lid 52a is pulled down using a finger etc., the lid 52a is turned toward the lower front (lower left in FIG. 4) to be horizontal to close the upper surface of the container portion 52c [see FIG. 4B].

While an outer box member of the container portion 52c is opaque, the lid 52a is transparent, which allows tablets stored in the container portion 52c to be visually checked from the outside, even if the lid 52a is closed. Moreover, stored tablets can be visually checked from above utilizing light that passes through the half mirror 52b. In addition, stored tablets reflected in the half mirror 52b can be visually checked from below utilizing light reflected by the half mirror 52b.

Further, as illustrated in FIGS. 3A and 4B, the tablet feeder storage portions 20A to 20C are provided, for each of the tablet feeders 52 mounted thereon, with a light emitting device 26 for input guide configured to inform a person that inputs tablets of the tablet feeder 52 to which tablets are to be input, and a lid open-close state detecting means 29.

The light emitting device 26 for input guide [see FIG. 4B] is formed from an LED display unit, for example, and provided in a back plate portion 23A that extends upright in rear of the lid 52a from a side located in the direction in which the lid 52a is opened, among the sides of the shelf 23 which supports the tablet feeders. One light emitting device 26 is provided for each of the tablet feeders 52 [see FIG. 3A]. The light emitting devices 26 are lit up according to control by the control system CS [FIG. 6B] to inform a person that inputs tablets of the tablet feeder 52 to which tablets are to be supplied. Light from the light emitting device 26 [see FIG. 4B] is radiated to a back plate portion 52e of the lid 52a of the corresponding tablet feeder 52. Light is diffused when the light passes through the back plate portion 52e [see the dash-double-dot arrows illustrated in FIG. 4B] to widely illuminate the inner surfaces of the lid 52a. As a result, the entire lid 52a seems to emit light [see the second tablet feeder 52 from the right in FIGS. 3A and 3C].

The lid open-close state detecting means 29 [see FIG. 3A] is mainly formed from a magnetic sensor, for example, and provided in the back plate portion 23A of the shelf 23 as with the light emitting device 26, and located in rear of the corresponding tablet feeder 52 to detect whether the corresponding lid 52a is in an opened state or a closed state. It is possible to detect whether the lid 52a is in an opened state or a closed state by fixing a permanent magnet or a magnetic substance to the lid 52a and detecting variations in the distance from the permanent magnet or the magnetic substance using the magnetic sensor.

In the present embodiment, the lid open-close state detecting means 29 is configured to detect not only whether or not the lid 52a is opened enough to allow input of tablets, but also whether or not the lid 52a is closed enough to prevent overflow of tablets. For example, the opened state of the lid 52a can be detected based on the difference in output values from a plurality of magnetic sensors with different sensitivity levels by providing such magnetic sensors in the back plate portion 23A. Alternatively, the opened state of the lid 52a can also be detected through a comparison between an output value from a single magnetic sensor and a plurality of thresholds at different levels.

The result of the detection by the lid open-close state detecting means 29 is transferred to the control system CS which has a function of managing input of tablets. When it is seen based on the value detected by the lid open-close state detecting means 29 that the relevant lid 52a has been opened from a fully closed state [see FIG. 3A] to a state in which input of tablets is allowed [see FIG. 3B], the control system CS determines that input of tablets to the corresponding tablet feeder 52 has been started. Meanwhile, when it is seen based on the detection by the lid open-close state detecting means 29 that the lid 52a has been closed from the state in which input of tablets is allowed [see FIG. 3B] to the fully closed state in which overflow of tablets can be prevented (the lid 52a has been returned to the state in FIG. 3A), the control system CS determines that input of tablets to the corresponding tablet feeder 52 has been completed. Further, when it is seen based on the detection by the lid open-close state detecting means 29 that the lid 52a stays in an intermediate state between the opened state and the closed state for a predetermined time or more, the control system CS determines that the lid 52a is in an error state in which the lid 52a is not appropriately opened or closed, and changes the color of light emitted from the light emitting device 26 corresponding to the relevant tablet feeder 52, flashes the corresponding light emitting device 26 [see the second light emitting device 26 from the right in FIG. 3C], or issues an alarm using the touch screen 15, a buzzer (not illustrated), etc.

As discussed earlier, when the control system CS selects one tablet feeder 52 at a time as the tablet input destination, the control system CS lights up the light emitting device 26 corresponding to the selected tablet feeder 52 to clearly indicate the tablet input destination [see the second light emitting device 26 from the right in FIG. 3A]. The color of light and the state of flashing differ between the lit state of the light emitting device 26 during normal times [see FIG. 3A] and the lit state of the light emitting device 26 in the error state discussed above [see FIG. 3C].

The movable rack 24 can be lightly turned using a hand or a finger with the lower end portion of the movable rack 24 coupled to the lower end portion of the front surface of the front panel 25 via a hinge structure [see FIGS. 2D, 2E, and 3]. When the free end of the movable rack 24 is flipped up [see FIGS. 2A to 2C], the movable rack 24 takes the vertical posture to be seemingly affixed to the front panel 25. When the free end of the movable rack 24 is turned downward about the hinge structure, on the contrary, the movable rack 24 serves as a table that allows a small article such as a pharmaceutical prescription to be placed thereon.

As described above, the upper tablet collecting portion (see FIG. 5) is disposed right next to the tablet feeder storage portions 20A to 20C in three levels, and guides and allows tablets discharged from the tablet feeder storage portions 20A to 20C to be dropped downward. The upper tablet collecting portion 30 is also supported by a collecting portion sliding mechanism 37 inside the medicine storage portion 13 to be slidable in the front-rear direction [see FIGS. 5A and 5B], and can be drawn forward out of the medicine storage portion [see FIG. 5B]. In addition, the upper tablet collecting portion 30 is shorter in length in the front-rear direction than the tablet feeder storage portions 20A to 20C, and is located in rear of a left end portion 25A of the front panel 25 of the tablet feeder storage portions 20A to 20C when seen from the front [see FIGS. 1, 5A, and 5B].

With the left end portion 25A of the front panel 25 located in front of the upper tablet collecting portion 30, each front panel 25 constitutes relative draw-out position regulating means configured to prevent the upper tablet collecting portion 30 from being drawn out forward with respect to the tablet feeder storage portions 20A to 20C. Each front panel 25 also serves as a member configured to regulate the upper tablet collecting portion 30 being drawn forward out of the medicine storage portion 13.

The tablet feeder storage portions 20A to 20C which are equipped with such a front panel 25 are disposed only on the right side of the upper tablet collecting portion 30 when seen from the front [see FIG. 1B]. Since there is no regulating member, such as the front panel 25, on the left side of the upper tablet collecting portion 30 when seen from the front, the left side of the upper tablet collecting portion 30 is opened when the upper tablet collecting portion 30 is drawn forward out of the medicine storage portion 13 [see FIG. 5B].

As illustrated in FIGS. 5C to 5E, the upper tablet collecting portion 30 includes a frame member 31 that is thin and rectangular, and two side surface portions, namely a first side wall 35 and a second side wall 38, located in the thickness direction of the frame member 31. The first side wall 35 is disposed on the left, opened side surface which does not face the tablet feeder storage portions 20A to 20C, of the two side surfaces of the frame member 31, and is mainly formed from a plate material removably mounted to close the side surface. Three tablet receiving ports 32 are formed to open in the second side wall 38, which is located on the right side of the frame member 31, at intervals in the vertical direction to receive tablets discharged from the tablet feeders 52 of the three tablet feeder storage portions 20A to 20C. In addition, the grip 33 is provided at the front end of the frame member 31, and a side wall holding member 34 is provided at the lower end portion of the frame member 31 and located below the first side wall 35 to receive the lower end portion of the first side wall 35 from below.

Small retention members 36 of a lever operated type, for example, are provided at the upper part of the first side wall 35. The open side surface of the frame member 31 is closed when the lower end portion of the first side wall 35 is placed on the side wall holding member 34 to be received and the retention members 36 are retained by the frame member 31 with the first side wall 35 standing upright [see FIG. 5C]. When the retention members 36, 36 are all disengaged, meanwhile, the upper part of the first side wall 35 is released from the open side surface of the frame member 31 [see FIG. 5D]. In the present embodiment, the side wall holding member 34 has a hook structure, for example, and slightly loosely receives the lower end portion of the first side wall 35. Thus, the first side wall 35 is held in a slightly tilted state. Further, when the first side wall 35 is lifted with hands placed on both the left and right ends, for example, of the first side wall 35, the first side wall 35 is completely released from the frame member 31 to significantly expose the inside of the frame member 31 [see FIG. 5E].

As illustrated in FIGS. 2E and 3A, the manual lock 43 is provided on the front panel 25 of the tablet feeder storage portions 20A to 20C, as discussed already. FIGS. 6A to 6D each illustrates the draw-out locking mechanism 40 including the manual lock 43. The draw-out locking mechanism 40 includes an electric lock operating mechanism (41, 42, 44) that is electrically operable and a manual lock operating mechanism (43, 44) that is manually operable. In this case, preferably, an electromagnetic drive portion 41 that constitutes a main portion of the electric lock operating mechanism is mounted to the medicine storage portion 13, and the manual lock 43 and a turning member 44 that constitute a main portion of the manual lock operating mechanism are mounted to the tablet feeder storage portions 20A to 20C. In addition, the draw-out locking mechanism 40 is configured to be able to be unlocked by operation of any of the electric lock operating mechanism and the manual lock operating mechanism. With this configuration, electric wires can be easily installed, for example, since electric portions of the draw-out locking mechanism 40 are centrally located in the medicine storage portion 13. Moreover, work such as inspection and maintenance, which is performed with power supply blocked for safety etc., can be easily performed, since the draw-out locking mechanism 40 can be unlocked by not only operation of the electric portions but also operation of manual portions.

Specifically, constituent parts of the draw-out locking mechanism 40 are mounted to the front end portion of each of the tablet feeder storage portions 20A to 20C and the front end portion of the medicine storage portion 13. The draw-out locking mechanism 40 is equipped with the turning member 44 which is provided to each of the tablet feeder storage portions 20A to 20C together with the manual lock 43, the electromagnetic drive portion 41 which is provided at a frame portion of the medicine storage portion 13, and an advancing-retracting member 42 capable of advancing from the electromagnetic drive portion 41 toward the turning member 44 and retracting in reverse. The advancing-retracting member 42 is always biased toward the advanced side (leftward in FIG. 6A) by a spring etc. (not illustrated), and projects from the frame portion of the medicine storage portion 13 toward the corresponding tablet feeder storage portion (20A to 20C). When the distal end portion of the advancing-retracting member 42 is located in front of the turning member 44 [see FIG. 6A], a locked state in which the tablet feeder storage portion (20A to 20C) cannot be drawn forward out of the medicine storage portion 13 is established.

When the tablet feeder 52 as the tablet input destination is selected by the control system CS, the LED display unit 28 on the front surface of one of the tablet feeder storage portions (20A to 20C) that carries the selected tablet feeder 52 is lit up to clearly indicate that the tablet feeder storage portion is to be drawn out. At the same time, the control system CS electrically establishes an unlocked state out of the locked state [see FIG. 6C] by exciting the electromagnetic drive portion 41 of the draw-out locking mechanism 40 related to the tablet feeder storage portion to retract the advancing-retracting member 42. Therefore, an appropriate tablet feeder storage portion can be drawn out of the medicine storage portion 13 [see FIGS. 2B to 2D] as a worker places his or her hand on the grip 21 of the tablet feeder storage portion (20A to 20C) according to illumination guidance to pull the tablet feeder storage portion forward.

In addition, as illustrated in FIG. 6B, locked state detecting means 46 is provided in correspondence with each of the tablet feeder storage portions 20A to 20C. The locked state detecting means 46 is configured to detect whether or not each of the tablet feeder storage portions 20A to 20C is located within a range in which the draw-out locking mechanism can be locked. The locked state detecting means 46 is configured to detect whether or not the tablet feeder storage portions 20A to 20C are located at a predetermined position utilizing a magnetic sensor, a limit switch, etc.

As illustrated in FIG. 6B, an inclined surface 42A is formed at the distal end portion of the advancing-retracting member 42. When the draw-out locking mechanism 40 is electrically unlocked and the tablet feeder storage portion is drawn out, the advancing-retracting member 42 is advanced by the force of a spring etc. to a state in which the turning member 44 is located on the front side with respect to the inclined surface 42A. When it is attempted to move the tablet feeder storage portion back into the medicine storage portion 13 from this state, the turning member 44 abuts against the inclined surface 42A. When the tablet feeder storage portion is further pushed to be retracted, the advancing-retracting member 42 is retracted toward the electromagnetic drive portion (moved rightward in the drawing) against the spring etc. discussed earlier by a component force that acts on the inclined surface 42A. Therefore, when the tablet feeder storage portion (20A to 20C) which has been drawn out forward is pushed into the medicine storage portion 13, the turning member 44 temporarily retracts the advancing-retracting member 42 to move the advancing-retracting member 42 rearward [see the dash-double-dot line and the dot and dash line in FIG. 6B]. As a result, the tablet feeder storage portions 20A to 20C can be pushed in at any time, while draw-out of the tablet feeder storage portions 20A to 20C is normally locked except when an unlocking command is provided from the control system CS.

Moreover, in the present embodiment, as illustrated in FIG. 6D, when a key 45 is inserted into the manual lock 43 and turned to the unlocked side, the turning member 44 is also accordingly rotated to be in a posture and a state in which the turning member 44 is not engaged with the advancing-retracting member 42, which enables manual unlocking.

In the present embodiment, in addition, the control system CS issues an alarm also under the following conditions. The conditions are that the locked state detecting means 46 discussed above detects that the relevant tablet feeder storage portion (20A to 20C) is located within a range in which the draw-out locking mechanism 40 can be locked and that the lid open-close state detecting means 29 does not detect that the lids 52a are closed enough to prevent overflow of tablets [see FIGS. 3B and 3C]. Moreover, this alarm is issued more distinctly than the alarm discussed above issued when the lids are halfway closed, in order to reliably remind the worker.

Since the locked state detecting means 46 and the lid open-close state detecting portion 29 (not illustrated) are provided, it is detected that the tablet feeder storage portions 20A to 20C have been drawn out, and that the lids 52a of the tablet feeders 52 have been opened. As a result, it is possible to determine whether or not it is assumed that tablets have been input to an appropriate tablet feeder. In addition, since the locked state detecting means 46 and the lid open-close state detecting portion 29 are provided, it is also detected that the tablet feeder storage portions 20A to 20C have been pushed back into the medicine storage portion 13, and that the lids 52a of the tablet feeders 52 have been closed. As a result, it is possible to determine whether or not the tablet feeder 52 can proceed to discharge tablets with the tablet feeder storage portions 20A to 20C locked. Thus, by providing such detecting portions, it is possible to provide a tablet dispensing apparatus configured to detect whether the lids 52a of the tablet feeders 52 are appropriately closed when the tablet feeder storage portions 20A to 20C are locked.

### Operation of First Embodiment

The mode of use and operation of the thus configured tablet dispensing apparatus 10 according to the first embodiment will be described.

The feature that supply of tablets to the standard tablet feeders 51, of the specific tablet-dedicated type, mounted on the standard tablet feeder storage portions 18 is performed with the tablet feeder storages 14 drawn out and with the tablet cassettes removed, the feature that the tablet falling path of the standard upper tablet collecting portion 17 is cleaned also with the tablet feeder storages 14 drawn out, the feature that supply of tablets to the manual dispenser of the manual tablet dispensation device-equipped portion 12 is performed by manually dispensing tablets to an attached unit of a drawable type or a spare dispensing unit of a removable type, and the feature that tablets to be dispensed are packed through coordinated operation of the above components, the lower tablet collecting portions 16A, 16B, and the packing device 11 under control by the control system CS, are known in the art, and thus are not described (see Patent Documents 2 to 4, for example). Operation etc. related to the tablet feeder storage portions 20A to 20C and the upper tablet collecting portion 30 will be discussed in detail below.

In the tablet dispensing apparatus 10, when the tablet feeder storages 14 and the tablet feeder storage portions 20A to 20C are housed in the housing 19 of the tablet dispensing apparatus 10 and brought into a stand-by state [see FIGS. 1 and 2A], the tablet feeder storages 14 are retained in the housing 19 by a locking mechanism (see FIG. 5 of Patent Document 4, for example), the tablet feeder storage portions 20A to 20C are retained in the housing 19 by the relevant draw-out locking mechanism 40 [see FIG. 6A], and the upper tablet collecting portion 30 is retained in the housing 19 by the front panel 25 of the tablet feeder storage portions 20A to 20C (see FIG. 1).

When pharmaceutical indication data are set to the control system of the tablet dispensing apparatus 10 by operating the touch screen 15 or through processing by a higher-level pharmaceutical management system, the content of the pharmaceutical indication is displayed on the touch screen 15 by the control system CS.

The touch screen 15 is externally mounted to the medicine storage portion 13 to be easily changeable in position and posture, and thus work is preferably performed while manually moving the touch screen 15 to an easily seeable and operable position and changing the direction thereof. Repeated description will be omitted hereinafter.

Further, consider the case that tablets to be dispensed are not included in the standard tablet feeders 51, of the specific tablet-dedicated type, in the tablet feeder storages 14 or the tablet feeders 52, of the multiple tablet-compatible type, of the tablet feeder storage portions 20A to 20C. In this case, first, a search is made for vacant tablet feeders, that is, those to which tablets have not been allocated or those from which all the tablets have been discharged, from the plurality of tablet feeders 52 of the multiple tablet-compatible type through a data management process by the control system CS. If a vacant tablet feeder 52 is found by the control system CS, the tablet feeder 52 is selected as a tablet feeder to which the tablets are to be allocated. If no vacant tablet feeder 52 is found, a process of allocating the tablets to a manual dispenser is performed.

For example, as illustrated in FIGS. 2D, 2E, and 3, if the tablets to be dispensed are allocated to one tablet feeder 52 of the tablet feeder storage portion 20C, a list of the target tablets is displayed on the touch screen 15, and thus the worker prepares the target tablets while seeing the list, and performs the work of supplying the target tablets. When there are a plurality of kinds of target tablets, the worker performs the work of supplying the target tablets in an appropriate order and one kind at a time. In the supply work, first, the control system CS acquires identification information such as a barcode affixed to a tablet container etc.

Then, the light emitting device 26 (LED display unit) related to the tablet feeder 52 of the tablet feeder storage portion 20C which has been selected as the allotment destination is lit up under control by the control system CS [see the second tablet feeder 52 and light emitting device 26 from the right in FIG. 3A].

In addition, the LED display unit 28 on the front surface of the tablet feeder storage portion 20C which carries the tablet feeder 52 described above is also lit up under control by the control system CS, and further the draw-out locking mechanism 40 related to the tablet feeder storage portion 20C is electrically brought from the locked state into the unlocked state [see FIG. 6C].

Therefore, the tablet feeder storage portion 20C can be drawn out of the medicine storage portion 13 [see FIGS. 2B to 2D] as the worker places his or her hand on the grip 21 of the tablet feeder storage portion 20C according to illumination guidance to pull the tablet feeder storage portion 20C forward.

Then [see FIGS. 2D and 2E], the worker identifies the relevant tablet feeder 52 according to illumination guidance by the light emitting device 26 on the right side surface of the tablet feeder storage portion 20C which has been drawn out [see FIG. 3A], and manually opens the lid 52a of the tablet feeder 52. At that time, light emitted from the light emitting device 26 is scattered inside the lid 52a to light up or color the entire lid 52a, and thus there is a significantly low possibility to mistake the target tablet feeder 52. Even if the lid 52a of a different tablet feeder 52 starts being opened by mistake, however, the control system CS issues an alarm in that case, and therefore the mistake is immediately noticed. At that time, the lid 52a is immediately and fully closed, and the lid 52a of an appropriate tablet feeder 52 is opened [see FIG. 3B].

When the appropriate lid 52a is opened wide enough, that is, the lid 52a is opened enough to allow input of tablets, the lid 52a being opened is detected by the lid open-close state detecting means 29, and the light emitting device 26 is turned off under control by the control system CS which has received the detection result [see FIG. 3B]. Therefore, the lid 52a is not dazzling any more, and the inside of the container portion 52c is easily seeable.

At an appropriate time before or after that, the worker turns the foremost movable rack 24 forward into a horizontal orientation for the tablet feeder storage portion 20C which has been drawn out and the other tablet feeder storage portions 20A and 20B [see FIGS. 2D, 2E, and 3], and places a tablet bottle, a pharmaceutical prescription, etc. (not illustrated) on the movable rack 24.

Now that preparation has been made to input tablets into an appropriate tablet feeder 52, the worker inputs an appropriate quantity of tablets, and performs an adjustment to adapt an input tablet dimension adjustment mechanism of the tablet feeder 52 to the dimensions of the tablets to be input.

Specifically, for the tablet feeders 52 of the multiple tablet-compatible type, most adjustments can be immediately and adequately made by setting sample tablets to an appropriate location of the tablet feeders 52 for setting sample tablets, and other adjustment work is also performed if necessary.

Further, when additional information such as detailed information on tablets is also required, the worker may provide the necessary information to the control system CS by operating the touch screen 15 etc.

When input of tablets to the tablet feeder 52 is finished, the worker manually closes the lid 52a which has been opened. When the lid 52a is closed enough to prevent overflow of tablets, the lid 52a being closed is detected by the lid open-close state detecting means 29, and the control system CS which has received the detection result proceeds with control. When it is desired at that time to reconfirm the state of tablets stored in the tablet feeder 52 to which input of tablets has been finished or a different tablet feeder 52 on the same tablet feeder storage portion 20C, the state of stored tablets can be easily confirmed without opening the lid 52a, by looking through the lid 52a and the half mirror 52b if the lid 52a is provided in the lower level, and seeing an image reflected by the half mirror 52b through the front surface of the lid 52a when the lid 52a is provided in the upper level.

After that, the worker puts away things on the movable rack 24, flips up the movable rack 24, and further pushes the tablet feeder storage portion 20C into the medicine storage portion 13 [see FIG. 2A].

Then, the tablet feeder storage portion 20C is locked by the relevant draw-out locking mechanism 40 to be retained in the medicine storage portion 13 [see FIG. 6B].

Normally, preparation for tablets of one type has been completed now. When the lid 52a of the tablet feeder 52 of the multiple tablet-compatible type to which tablets have been input is not closed enough to prevent overflow of tablets for some reason [see FIG. 3C], e.g. when the lid 52a seems closed at a glance but is not fully closed in a situation in which the lid 52a is not easily closed because of tablet pieces being caught etc., the content of control by the control system CS is different from that during normal times as discussed in detail next.

Specifically, under control by the control system CS, the light emitting device 26 corresponding to the relevant tablet feeder 52 of the tablet feeder storage portion 20C and the LED display unit 28 on the front surface of the relevant tablet feeder storage portion 20C are caused to look differently from when input guide is given, e.g. by flashing, being colored differently, etc., to issue an alarm [see FIG. 3C]. And the touch screen 15 is caused to display an alarm message or output an alarm sound, under control by the control system CS. When the worker who has noticed the trouble closes the relevant lid 52a again, the relevant tablet feeder storage portion 20C is locked by the draw-out locking mechanism 40, and all the alarms etc. are resolved, under control by the control system CS.

When the tablet feeder storage portion 20C is pushed into the medicine storage portion 13 without the worker noticing such alarms, the draw-out locking mechanism 40 related to the tablet feeder storage portion 20C is maintained in the unlocked state under control by the control system CS [see FIG. 6C], and more distinct alarms are issued. Thus, the worker immediately draws out the relevant tablet feeder storage portion 20C again in response to such alarms, and closes the lid 52a discussed above again.

Now that preparation related to tablets of one type has been completed, the worker repeatedly performs similar work for other tablets if necessary.

When all preparations have been completed, the control system CS is caused to start automatic dispensation by operating the touch screen 15 etc.

Then, tablets to be packed are automatically discharged from the standard tablet feeders 51 of the specific tablet-dedicated type and also from the tablet feeders 52 of the multiple tablet-compatible type similarly in tablet units, tablets that have been manually dispensed are automatically discharged from the manual tablet dispenser (12) basically in packing units, and such tablets are merged together in the lower tablet collecting mechanisms 16A, 16B and thereafter packed by the packing device 11.

When the packing process is performed using the tablet feeders 52 of the multiple tablet-compatible type and the packing process is repeated performed several times, it is also necessary to clean the inside of the upper tablet collecting portion 30 which constitutes the tablet guide path. On such occasions, the worker first draws all the tablet feeder storage portions 20A to 20C forward out of the medicine storage portion 13 after stopping operation of the tablet dispensing apparatus 10 [see FIG. 5A]. In that event, the tablet feeder storage portions 20C can be drawn out forward by inserting a key into the manual lock 43 on the front surface of the tablet feeder storage portion 20C to be drawn out [see FIG. 2E] and turning the key [see FIG. 6D] to manually unlock the tablet feeder storage portion 20C.

When all the tablet feeder storage portions 20A to 20C have been drawn out [see FIG. 5A], nothing prevents the upper tablet collecting portion 30 from being drawn out forward. Thus, a hand is placed on the grip 33 on the front surface of the upper tablet collecting portion 30 to pull the grip 33 forward to draw the upper tablet collecting portion 30 out of the medicine storage portion 13 [see FIG. 5B]. Then, a side surface located on the opposite side of the tablet feeder storage portions 20A to 20C, of the two side surfaces of the upper tablet collecting portion 30, is significantly exposed. Since the first side wall 35 is mounted to the exposed side surface [see FIGS. 5B and 5C], the worker performs the subsequent work from the exposed side surface. First, when the worker disengages the retention members 36 at the upper part of the first side wall 35, the first side wall 35 is tilted [see FIG. 5D]. The first side wall 35 is maintained in the state of being slightly tilted, since the lower end portion of the first side wall 35 is loosely held by the side wall holding member 34.

The first side wall 35 in that state can be easily removed from the frame member 31 by the worker lifting the first side wall 35. Thus, the worker can easily clean the first side wall 35 at a location away from the frame member 31.

In addition, the inside of the frame member 31 is significantly exposed when the first side wall 35 is removed [see FIG. 5E]. Thus, the worker can easily clean the frame member 31 while facing the frame member 31.

In this manner, the tablet falling path of the upper tablet collecting portion 30 is easily cleaned. Then, after cleaning, subsequent automatic tablet dispensation can be appropriately performed after performing the operations in the order opposite to that discussed above.

### Second Embodiment

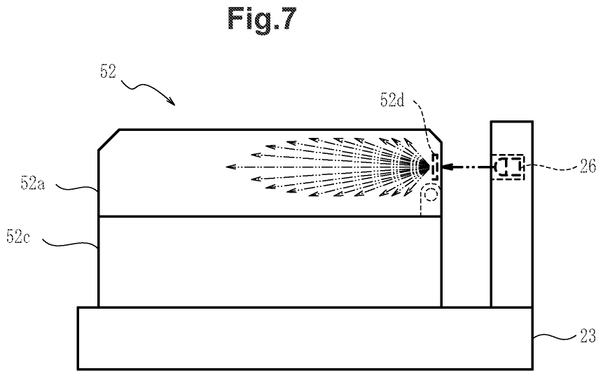

FIG. 7 illustrates a different structure of the tablet feeder 52 of the multiple tablet-compatible type that is usable in the present embodiment. The tablet feeder 52 is different from the tablet feeder 52 illustrated in FIG. 4 in that a light scattering portion 52d has been added to the lid 52a of the tablet feeder 52.

When the light scattering portion 52d is present in the light transmission path from the light emitting device 26, light transmitted from the light emitting device 26 to the lid 52a is diffused to an increased degree when the light transmits the light scattering portion 52d (see the dash-double-dot arrows in FIG. 7). As a result, the lid 52a tends to be lit up more entirely and uniformly, and thus the relevant tablet feeder 52 is more easily visually recognizable.

The light scattering portion 52d which is provided at the relevant portion of the lid 52a of the tablet feeder 52 can be implemented by performing additional processing such as increasing the surface roughness of the relevant portion at which the light scattering portion 52d is provided, or affixing a rough, transparent light diffusion plate to the relevant portion. The relevant portion is a portion distinctly penetrated by light transmitted from the light emitting device 26 when the lid 52a is closed.

### Third Embodiment

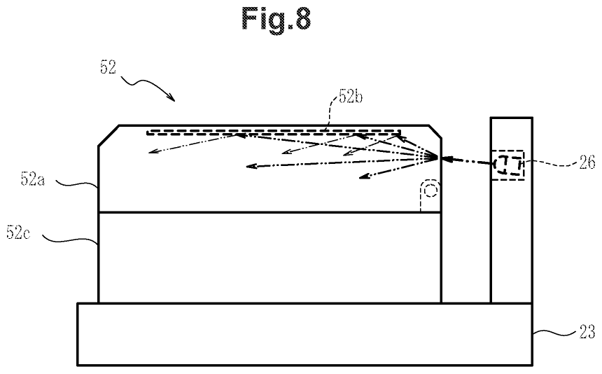

FIG. 8 illustrates a different structure of the tablet feeder 52 of the multiple tablet-compatible type that is usable in the present embodiment. The tablet feeder 52 is different from the tablet feeder 52 illustrated in FIG. 4 in that the direction of light transmitted from the light emitting device 26 is slightly inclined upward and that light is applied to the half mirror 52b (semi-transparent mirror) on the lower surface of the lid 52a of the tablet feeder 52 when the lid 52a is closed.

This configuration is easily implemented by tilting the light emitting device 26. When this configuration is adopted, it is not necessary to provide an additional member such as the light scattering portion 52d as in the second embodiment, which makes it possible to avoid a cost increase.

In this case, light transmitted from the light emitting device 26 into the lid 52a is diffused in the lid 52a to an increased degree utilizing the reflection function of the half mirror 52b (see the dash-double-dot arrows in FIG. 8), which enhances viewability. Moreover, the reflection function enhances diffusion and improves viewability better on the lower front side (lower left side in FIG. 8) of the tablet feeder 52.

On the contrary, light emitted to the upper front side (upper left side in FIG. 8) of the tablet feeder 52 is viewable from that side to an increased degree because of the transmission function of the semi-transparent mirror.

Therefore, the viewability of the light emitting device 26 when lit up is enhanced irrespective of whether the eye position of a person that works on the front side (left side in FIG. 8) is high or low.

### [Others]

In the embodiments described above, the lid 52a which is coupled via a support shaft to the rear end portion of the tablet feeder 52 of the multiple tablet-compatible type is mentioned as a specific example of a lid provided in correspondence with the tablet feeder to be able to open and close the upper surface of the tablet feeder. However, the present invention is not limited to the aspect of the lid of the tablet feeder storage portion according to the embodiments described above. It is only necessary that the lid 52a should be able to open and close the upper surface of the tablet feeder 52. For example, the rear end portion of the lid may be coupled to the shelf 23, or the lid may be elevated and lowered to be opened and closed, rather than being rotated to be opened and closed.

While the lid 52a is opened and closed by only an external force such as a human force in the embodiments described above, a mechanical force may be applied to assist, rather than to hinder, an operation by a human force. For example, the tablet feeder 52 may be provided with weak locking means configured to operate with the lid closed and be unlocked by a light, manual opening operation, a still weaker spring hinge operable to bias the lid in the opening direction, etc.

In the embodiments described above, when there are a plurality of tablet feeders 52 of the multiple tablet-compatible type to be supplied with tablets, the tablet feeder storage portions (20A to 20C) are individually put into and out of the medicine storage portion 13 irrespective of whether or not the tablet feeders 52 are mounted on the same tablet feeder storage portion (20A to 20C). When a plurality of tablet feeders 52 to be supplied with tablets are mounted on the same tablet feeder storage portion (20A to 20C), however, the worker may be informed of the situation through combined use of guidance, confirmation, etc. on the touch screen 15, and may be allowed to sequentially supply tablets to the plurality of tablet feeders 52 with the tablet feeder storage portions (20A to 20C) kept drawn out.

While the manual tablet dispensation device-equipped portion 12 and the tablet feeder storage portions (20A to 20C) are installed at different heights in the embodiments described above, the manual tablet dispensation device-equipped portion 12 and the tablet feeder storage portions (20A to 20C) may be installed at the same height or close to each other (see Patent Documents 3 and 4, for example). It is assumed that various types of tablets are dropped directly into the manual tablet dispenser (12) or a spare dispensing unit removably mounted thereto with the tablets manually scattered. However, it is only necessary that tablets of one type should be input to the standard tablet feeders 51, of the specific tablet-dedicated type, in the tablet feeder storages 14 or the tablet feeders 52, of the multiple tablet-compatible type, of the tablet feeder storage portions 20A to 20C, and tablets may be input thereto using a bottle or a measuring cup, or tablets may be manually input thereto without scattering the tablets.

A tablet discharge control algorithm (the procedure for control as to which of the large number of tablet feeders is caused to perform discharge operation at each dispensing timing) for the tablet feeders 52 of the multiple tablet-compatible type may be the same as that for the standard tablet feeders 51 of the specific tablet-dedicated type. Therefore, a common discharge control program is used for the standard tablet feeders 51 and 52.

On the contrary, a separate discharge control program is used for the manual tablet dispenser (12) with a different tablet discharge control algorithm.

In the embodiments described above, when the tablet feeder 52 of the multiple tablet-compatible type as the tablet input target is selected using the touch screen 15, the light emitting device 26 of the tablet feeder storage portion (20A to 20C) which carries the selected tablet feeder 52 is lit up, and the draw-out locking mechanism 40 of the tablet feeder storage portion (20A to 20C) is immediately unlocked. However, a different method may be employed. For example, when an operation member such as a push button is provided on the front surface of the tablet feeder storage portions (20A to 20C) and there are a plurality of tablet feeder storage portions 20A to 20C as the tablet input target, all of the plurality of relevant light emitting devices 26 may first be lit up, the draw-out locking mechanism 40 of the relevant tablet feeder storage portion 20A to 20C may be unlocked after waiting for any one of the operation members to be operated, and the relevant light emitting device 26 may be flashed etc. to be clearly indicated.

While a tablet feeder of a type with replaceable sample tablets is used as the tablet feeders 52 of the multiple tablet-compatible type in the embodiments described above, the tablet feeders of the multiple tablet-compatible type are not limited to the type with replaceable sample tablets.

A cutter mechanism for cutting tablets may be incorporated in or combined with the tablet feeders 52 of the multiple tablet-compatible type and also the standard tablet feeders 51 of the specific tablet-dedicated type.

In the embodiments described above, a tablet bottle and a pharmaceutical prescription are mentioned as articles that can be temporarily placed on the movable rack 24, which is rendered horizontal, at the front end of the tablet feeder storage portions 20A to 20C. However, the present invention may go further than that, and an imaging device such as a camera provided on the housing 19 of the tablet dispensing apparatus 10, a portable terminal equipped with an image capture function, etc. may be used to read a barcode or other information affixed to the tablet bottle or the pharmaceutical prescription on the movable rack 24, and the information may be transferred to the control system CS to be utilized for checking, monitoring, etc. of dispensation work.

### INDUSTRIAL APPLICABILITY

The present invention is not limited to the use with tablet dispensing apparatuses exclusively for tablets, and the present invention is also applicable to tablet dispensing apparatuses integrated with a powder dispensing apparatus.

### DESCRIPTION OF REFERENCE NUMERALS

10 tablet dispensing apparatus
11 packing device
12 manual tablet dispensation device-equipped portion
13 medicine storage portion
14 tablet feeder storage
15 touch screen (operation panel)
15a support portion
16A, 16B first and second lower tablet collecting portions
17 standard upper tablet collecting portion
18 standard tablet feeder storage portion
19 housing
20A to 20C tablet feeder storage portion (for tablet feeders of multiple tablet-compatible type)
21 grip
22 draw-out mechanism
23 shelf
24 movable rack
25 front panel
26 light emitting device (LED)
28 LED display unit
29 lid open-close state detecting means
30 upper tablet collecting portion
31 frame member
32 tablet receiving port
33 grip
34 side plate holding member
35 first side wall
36 retention member
37 collecting portion sliding mechanism
38 second side wall
40 draw-out locking mechanism
41 electromagnetic drive portion
42 advancing-retracting member (engagement member)
43 manual lock
44 swing member (engagement member)
45 key
46 locked state detecting means
51 tablet feeder of specific tablet-dedicated type
52 tablet feeder of multiple tablet-compatible type
52a lid
52b half mirror (semi-transparent mirror)
52c container portion (body portion)
52d light scattering portion

1. A tablet dispensing apparatus comprising:
a plurality of tablet feeder storage portions configured to store a plurality of tablet feeders and disposed in line in a vertical direction;
an upper tablet collecting portion disposed along the plurality of tablet feeder storage portions and including a tablet falling path that guides and allows tablets to be dropped downward from the plurality of tablet feeder storage portions;
a medicine storage portion configured to house at least the plurality of tablet feeder storage portions and the upper tablet collecting portion;
a lower tablet collecting portion disposed below the upper tablet collecting portion and configured to guide the tablets dropped from the upper tablet collecting portion to a dispensing portion;
a plurality of storage portion sliding mechanisms configured to support the plurality of tablet feeder storage portions to be individually slidable forward; and
a collecting portion sliding mechanism configured to support the upper tablet collecting portion to be slidable forward independently of the plurality of tablet feeder storage portions.

2. The tablet dispensing apparatus according to claim 1, further comprising
a draw-out regulating structure that allows the upper tablet collecting portion to be drawn out forward only when all the plurality of tablet feeder storage portions are drawn out forward.

3. The tablet dispensing apparatus according to claim 1, further comprising:
a plurality of draw-out locking mechanisms disposed correspondingly to the plurality of tablet feeder storage portions and configured to prevent the plurality of tablet feeder storage portions from sliding forward along the storage portion sliding mechanisms, respectively.

4. The tablet dispensing apparatus according to claim 3, further comprising
a locked state detecting portion configured to detect whether or not the plurality of draw-out locking mechanisms are in a locked state.

5. The tablet dispensing apparatus according to claim 3, further comprising
an electric lock operating mechanism that is electrically operable and a manual lock operating mechanism that is manually operable, wherein:
a main portion of the electric lock operating mechanism is mounted to the medicine storage portion, and a main portion of the manual lock operating mechanism is mounted to the tablet feeder storage portions; and
the draw-out locking mechanisms are configured to be able to be unlocked by operation of any of the electric lock operating mechanism and the manual lock operating mechanism.

6. The tablet dispensing apparatus according to claim 1, wherein:
the tablet feeders are each configured to be able to store a plurality of tablets of one kind selected from a large number of kinds of tablets of different shapes and sizes, and have a function of discharging the tablets one by one; and
the tablet feeders and the tablet feeder storage portions are configured to allow supply of tablets with the plurality of tablet feeders mounted to the tablet feeder storage portions.

7. The tablet dispensing apparatus according to claim 6, wherein:
the medicine storage portion houses a plurality of standard tablet feeder storage portions including a plurality of standard tablet feeders each including tablet cassette configured to store a plurality of tablets of the same shape and size and of the same kind, and one or more standard upper tablet collecting portions disposed along the plurality of standard tablet feeder storage portions and including one or more tablet falling paths that guide and allow the tablets to be dropped downward from the plurality of standard tablet feeder storage portions;
a plurality of intermediate collecting portions are disposed between the one or more standard upper tablet collecting portions and the upper tablet collecting portion, and the lower tablet collecting portion, the plurality of intermediate collecting portions being configured to temporarily store the plurality of tablets dropped from the one or more standard upper tablet collecting portions; and
the tablets are dropped from the plurality of intermediate collecting portions to the lower tablet collecting portion.

8. The tablet dispensing apparatus according to claim 4, wherein:
the plurality of tablet feeders each have a tablet input port in an upper surface thereof;
the tablet feeder storage portions each include a plurality of lids operable to individually open and close the tablet input ports of the plurality of tablet feeders; and
the tablet dispensing apparatus further includes a lid open-close state detecting portion configured to detect whether or not the plurality of lids are in an opened state or a closed state.

9. The tablet dispensing apparatus according to claim 8, wherein
the lid open-close state detecting portion is configured to be able to detect whether or not the lids are opened enough to allow the tablets to be input through the tablet input ports and whether or not the lids are completely closed.

10. The tablet dispensing apparatus according to claim 8, wherein
the lids are each formed from a transparent material that allows looking inside the tablet feeders from above.

11. The tablet dispensing apparatus according to claim 10, wherein
the lids are each provided with a half mirror configured to allow looking inside the tablet feeders from above and to reflect light directed upward from below.

12. The tablet dispensing apparatus according to claim 10 wherein:
the tablet feeder storage portions are each provided with a plurality of light emitting devices provided in proximity to the plurality of tablet feeders to light up in order to indicate a tablet feeder that needs to be supplemented with the tablets; and
the lids are each configured to introduce light inside the tablet feeder from the light emitting device corresponding thereto.

13. The tablet dispensing apparatus according to claim 12, wherein
the lids are each provided with a light scattering portion configured to diffuse light from the light emitting devices introduced inside the tablet feeders.

14. The tablet dispensing apparatus according to claim 13, wherein
the half mirror is also used as the light scattering portion.

15. The tablet dispensing apparatus according to claim 2, wherein
the upper tablet collecting portion has an assembly structure such that an opposite side surface portion that is opposite to a side surface portion that faces the plurality of tablet feeder storage portions when the upper tablet collecting portion is drawn forward prevents an outflow of powder from the tablet falling path when the upper tablet collecting portion is housed in the medicine storage portion, and enables cleaning of the tablet falling path when the upper tablet collecting portion is drawn out of the medicine storage portion.

16. The tablet dispensing apparatus according to claim 15, wherein
the opposite side surface portion is formed from a plate material to be inclined about a lower end portion thereof in a direction away from the plurality of tablet feeder storage portions when the upper tablet collecting portion is drawn forward.

17. The tablet dispensing apparatus according to claim 2, wherein:
the tablet feeder storage portions each include a shelf supported by the storage portion sliding mechanism and to which the plurality of tablet feeders are mounted in a row, and a front panel disposed at a front end portion of the shelf and extending in a direction orthogonal to the shelf; and
a part of the front panel faces forward in a sliding direction of the upper tablet collecting portion to constitute a part of the draw-ort regulating structure.

18. The tablet dispensing apparatus according to claim 17, wherein
a movable rack is provided on a front surface of the front panel, the movable rack being supported on the front panel via a hinge structure to be displaceable between a horizontal posture and a vertical posture.

19. The tablet dispensing apparatus according to claim 15, wherein
an operation panel for inputting instructions externally mounted to the medicine storage portion to be easily changeable in position.
